(19) United States
(12) Patent Application Publication
(10) Pub. No.: US 2011/0168329 A1
(43) Pub. Date: Jul. 14, 2011

(54) NOVEL POLYAMIDE-BASED HOT-MELT ADHESIVE COMPOSITION

(75) Inventors: Nicolas Sajot, Clairoix (FR); Christille Brunet, Paris (FR); Majdouline Lachhab, Tracy Le Val (FR)

(73) Assignee: BOSTIK S.A., COURBEVOIE (FR)

(21) Appl. No.: 12/997,351

(22) PCT Filed: Jun. 4, 2009
(86) PCT No.: PCT/FR2009/000647

§ 371 Date: Mar. 30, 2011

(30) Foreign Application Priority Data
Jun. 13, 2008 (FR) 0803286

(51) Int. Cl. B32B 37/12; C09J 177/08; C09J 175/02

(52) U.S. Cl. 156/330.9; 525/420.5

(57) ABSTRACT

1) Hot-melt adhesive composition comprising from 20 to 95% of a polyamide and from 5 to 80% of a supramolecular polymer capable of being obtained by reaction between 1-(2-aminoethyl)-2-imidazolidone (UDETA) and a mixture comprising: —from 51 to 100% of one or more dimers and/or trimers of fatty acids; and—from 0 to 49% of one or more monomers of fatty acids. 2) Use of said composition with a view to manufacturing disposable hygiene articles.

The subject matter of the present invention is a hot-melt adhesive composition comprising a polyamide and a supramolecular polymer, the units of which comprise a group of imidazolidone type. The present invention also relates to the use of said composition in various fields, including that of the manufacture of disposable hygiene products.

Hot-melt adhesives (HM adhesives) are substances which are solid at ambient temperature and which comprise neither water nor solvent. They are applied in the molten state after heating to a temperature generally of between 80 and 250° C., most often between 150 and 180° C., and solidify during cooling, thus forming a seal which ensures the attachment of the substrates to be assembled. These hot-melt adhesives are usually provided in the form of compositions which comprise a thermoplastic polymer and optionally a tackifying resin and a plasticizer.

Hot-melt adhesive compositions are used industrially in a wide range of applications, such as, for example, the manufacture of rigid packagings based on paper and board, the creation of bindings in the publishing industry, the production of various assemblies in the fields of electronics, motor vehicles or textiles, or the manufacture of disposable hygiene articles.

The latter field relates in particular to disposable diapers and to feminine protection products; hot-melt adhesives are used therein for the preparation of assemblies of thin sheets and of porous substrates of different materials by laminating. Mention may be made, as example of such assemblies, in the case of diapers, of the lamination of a PolyEthylene (PE) sheet with a nonwoven cloth of PolyPropylene (PP), the latter giving a silky appearance pleasing to the eye and to the touch.

The laminating of such sheets (or substrates) is carried out industrially by a process which comprises:
the heating (to a temperature of between 80 and 250° C. and preferably between 150 and 180° C.) of the hot-melt adhesive composition in a vat, referred to as melting pot, until it becomes molten, then
the coating of one of the two substrates to be assembled, resulting in the deposition on the latter, by means of a nozzle, of a layer of said composition in the molten state, the thickness of which is controlled and is generally between 1 and 500 μm, and finally
bringing the substrate thus coated into contact, under pressure, with the substrate to be laminated or assembled.

The devices used for the implementation of these laminating processes are generally machines which operate continuously with often high line speeds and in which, for example, both the components to be laminated or assembled (sheets, films or other substrates) and the final product, often denoted by the term of “complex”, are, due to their very large dimensions, packaged by winding off in the form of reels of large width and diameter.

The stage of coating with the molten hot-melt adhesive composition comprises passing it through one or more nozzles at a high pressure, of the order of a few bar to more than 100 bar, so as to obtain good contact (or wetting) with the substrate to be coated, which wetting contributes to giving, to the final assembly of the two substrates, the necessary level of cohesion. The latter is usually quantified by a “peel” test.

One aim of the present invention is to provide a hot-melt adhesive composition which makes it possible to obtain, for the assembling (or laminating) of two substrates, an acceptable and/or improved level of cohesion at the temperature of use of the complex product, which generally lies in a temperature range close to ambient.

It is also necessary for the hot-melt adhesive composition employed in the laminating process to exhibit certain physicochemical characteristics which render it suitable for this use.

Thus, said composition must remain homogeneous at the temperature corresponding to the stages of the process, in particular from the melting pot to the coating nozzle or nozzles. This homogeneous nature must also be maintained over time as manufacturers which employ the laminating process (such as, for example, manufacturers of disposable hygiene articles) may be driven to store the composition in the molten state in the melting pot for one or two days. Finally, the satisfactory progression of the coating stage requires that the viscosity of the adhesive be in a certain range generally, for a temperature in the vicinity of 150° c., between approximately 200 and 30 000 mPa·s, preferably between 1 and 15 Pa·s. As the viscosity generally varies in inverse proportion with the temperature, it is therefore necessary to heat the adhesive in the melting pot so as to bring its viscosity into the viscosity range required by the nozzle.

Another aim of the present invention is to provide a hot-melt adhesive composition which is homogeneous up to a high temperature, for example at a temperature of greater than 130° C., preferably equal to approximately 180° C., and the homogeneous nature of which is maintained after storage at this temperature for a few days, for example up to 3 days.

Another aim of the present invention is to provide a hot-melt adhesive composition exhibiting a reduced viscosity at high temperature, for example at approximately 150° C. Such a reduction is very desirable insofar as it makes it possible to lower the temperature to which it is necessary to bring the melting pot and to correspondingly achieve a saving in energy. This reduction also makes it possible to facilitate the transportation of the adhesive in the feed circuit of the machine, from the melting pot as far as the coating nozzles. Finally, it makes it possible, for a set coating temperature, to obtain, by virtue of the improved fluidity of the adhesive, more effective wetting of the substrate, which contributes to better cohesion of the final assembly.

Another aim of the present invention is to provide a hot-melt adhesive composition which makes possible the implementation of the coating stage of the laminating process at a lower temperature, thus offering the possibility of carrying out the coating of heat-sensitive substrates.

Another aim of the present invention is to provide a hot-melt adhesive composition which provides good cohesion of the final assembly at ambient temperature while exhibiting a reduced viscosity at high temperature, for example between 150 and 180° C., which thus facilitates the use thereof.

It has now been found that the above aims can be achieved in all or in part by means of the hot-melt adhesive composition which is the subject matter of the present invention.

The invention thus relates to a hot-melt adhesive composition comprising:
from 20 to 95% of a polyamide, and
from 5 to 80% of a supramolecular polymer, the unit of which comprises at least one radical chosen from the monovalent radicals of formulae (1) and (3) and a second radical chosen from the radicals of formulae (1) to (5) below:

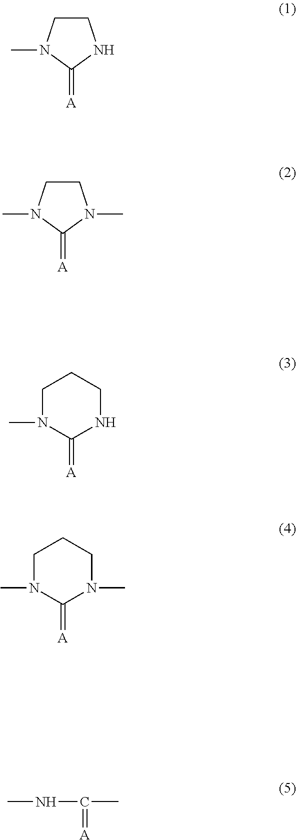

in which A represents an oxygen or sulfur atom or an NH group.

The percentages indicated in the present text to represent the contents of ingredients of a composition are, unless otherwise indicated, % weight/weight.

The expression “supramolecular polymer” denotes a chemical structure which is composed of the molecules of the same compound connected to one another via bonds of hydrogen type. This expression derives by analogy from the term “polymer”, which is conventionally used to denote a chemical structure obtained by the establishment of covalent chemical bonds between one (in the case of a homopolymer) or several (in the case of a copolymer) repeating elements known as “units”. By analogy, the compound constituting a supramolecular polymer is also denoted by the term of “unit”.

The supramolecular polymer included in the composition according to the invention can derive from one or more units having a mass which can vary from 200 to 9000 g/mol, preferably from 200 to 2000 g/mol.

The radicals of formulae (1) to (5) included in the unit of the supramolecular polymer constitute groups (“associative” groups) which make possible the establishment of the bonds of hydrogen type between the molecules corresponding to these units, resulting in the structuring of these molecules as supramolecular polymers.

Such supramolecular polymers are described in international applications WO 03/059964 and WO 2008/029065, which simply mention, among various uses, a use as additive in hot-melt adhesives.

It has now been found that the choice of a specific thermoplastic polymer, namely polyamide, results, in contrast to other thermoplastic polymers commonly used in hot-melt adhesives, in a hot-melt adhesive composition which advantageously exhibits both a homogeneous nature and a reduced viscosity at a temperature of between 150 and 180° C., while giving a good level of cohesion, at ambient temperature, of the assembly between two substrates and/or sheets of materials, in particular between sheets used in the field of disposable hygiene articles, such as PE and nonwoven PP.

The polyamides included in the hot-melt adhesive composition according to the invention are capable of being obtained by:
a condensation reaction of a diacid chosen from fatty acid dimers, dodecanedioic acid, sebacic acid, azelaic acid and adipic acid with a diamine chosen from ethylenediamine, piperazine, hexamethylenediamine, diethylenetriamine, triethylenetetramine, dipiperidylpropane and a polyoxypropylenediamine; or else
a polymerization reaction of a linear or cyclic amino acid chosen from caprolactam, lauryllactam or 11-aminoundecanoic acid.

The polyamides within the meaning of the present invention also include the copolyamides capable of being obtained by reaction of a mixture of diacids with a mixture of diamines, and also the block copolymers comprising a polyamide block capable of being obtained by the condensation or polymerization reactions defined above.

It is preferable to use, as diacid, a fatty acid dimer, adipic acid or their mixture and, as diamine, piperazine, ethylenediamine or their mixture.

The supramolecular polymer which can be used in the composition according to the invention can be prepared by the processes described in applications WO 03/059964 and WO 2008/029065.

Thus, the units of said polymer comprising at least one of the radicals of formulae (1) to (4) can be obtained by a process comprising the reaction of a compound of formula (6):

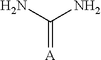

in which A is as defined above,
with a compound comprising one or more of the monovalent or divalent radicals of formulae (1′) to (4′):

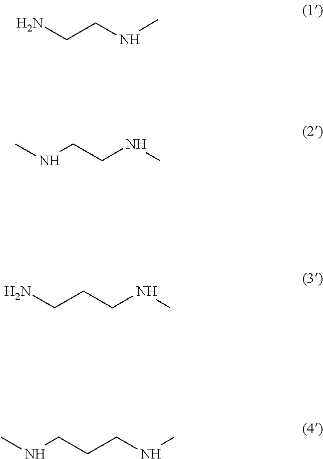

in which the carbon atoms can be substituted.

This reaction is a condensation/cyclization reaction obtained by simple heating and removal of ammonia.

According to a preferred alternative form, the substituent A of the formulae (1) to (5) of the radicals represents an oxygen atom.

According to an even more preferred alternative form, the unit of the supramolecular polymer comprises at least two imidazolidone radicals of formula (1) in which A represents an oxygen atom.

According to a very particularly preferred embodiment, the unit of the supramolecular polymer comprises from 1 to 3 R¹ radicals, each R¹ radical being composed of an imidazolidone of formula (1) connected via a divalent organic radical with a mass ranging from 14 to 300, preferably via a —CH₂—CH₂— group, to a —CO—NH— radical of formula (5).

Such R¹ radicals are capable of being obtained:
by reacting urea with DiEthyleneTriAmine (or DETA) of formula:

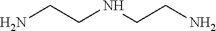

so as to obtain 1-(2-aminoethyl)-2-imidazolidone (also known as UreidoDiEthyleneTriAmine or UDETA) of formula:

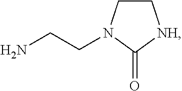

then
by reacting the latter compound with a compound carrying from 1 to 3 carboxyl functional groups.

A compound carrying from 1 to 3 amide functional groups of formula (5) is thus obtained, each of said functional groups thus being connected indirectly to an imidazolidone radical of formula (1) in which A represents an oxygen atom.

According to a first preferred alternative form, the supramolecular polymer employed in the hot-melt adhesive composition according to the invention is capable of being obtained by reaction between UDETA and a mixture comprising:
from 51 to 100% of one or more identical or different fatty acid dimers and/or of one or more identical or different fatty acid trimers; and
from 0 to 49% of one or more identical or different fatty acid monomers.

The dimeric and trimeric fatty acids are obtained by polymerization, at high temperature and under pressure, of unsaturated fatty acids, referred to as “monomers”, which comprise from 6 to 22 carbon atoms, preferably from 12 to 20, and originate from vegetable or animal sources. Mention may be made, as example of such unsaturated fatty acids (monomers), of the C₁₈ acids having one or two double bonds (respectively oleic acid or linoleic acid) obtained from tall oil, which is a byproduct from the manufacture of paper pulp.

After polymerization of these unsaturated fatty acids, a technical mixture is obtained comprising, on average, 30-35% of monocarboxylic acids (monomeric acids), often isomerized with respect to the starting acids, 60-65% of dicarboxylic acids (dimeric acids), with twice the carbon number with respect to the starting acids, and 5-10% of tricarboxylic acids (trimeric acids), having three times the carbon number with respect to the starting acids. The various commercial grades of dimeric, monomeric or trimeric acids, which can exist in the hydrogenated or nonhydrogenated form, are obtained by purification of this mixture. Mention may be made, among these, of the Pripol® range developed by Uniqema.

According to a more particularly preferred embodiment, the supramolecular polymer is capable of being obtained by a reaction, according to substantially stoichiometric amounts, of UDETA with a mixture of monomeric and/or dimeric and/or trimeric fatty acids resulting from the polymerization of predominantly C₁₈ unsaturated monomeric fatty acids, said mixture comprising:
from 1 to 3% of monomers,
from 75 to 80% of dimers, and
from 18 to 22% of trimers.

The latter mixture is available commercially under the name of Pripol® 1017 (Acid Number equal to 193.4 mg KOH/g) from Uniqema. The supramolecular polymer corresponding to the latter embodiment is hereinafter denoted by the term of SUPRA; the corresponding unit has an average molar mass of approximately 900 g/mol. Reference is made, for its preparation, to the abovementioned international application WO 2008/029065 and in particular to example 8.

According to a second preferred alternative form, the supramolecular polymer is capable of being obtained by reaction of UDETA with a dicarboxylic acid of α, ω type composed of a saturated or unsaturated, linear or branched hydrocarbon radical having from 9 to 66 carbon atoms, the main chain of which has, at its two ends, the —COOH group.

A hot-melt adhesive composition comprising from 65 to 95% of polyamide and from 5 to 35% of supramolecular polymer is more particularly preferred.

In addition to the polyamide and the supramolecular polymer, the hot-melt adhesive composition according to the invention comprises from 0 to 40% of at least one tackifying resin, another polymer, a plasticizer or an oil, an antioxidant, a fragrance, a pigment, a dye or a filler, such as calcium carbonate, silica, a clay or talc.

The hot-melt adhesive composition according to the invention is prepared by simple blending of its components in the molten state at a temperature of between 80 and 200° C. until a homogeneous blend is obtained. Simple blending in a pot with a slow-speed rotary stirrer is sufficient. Other mixing devices, such as mixers, kneaders or extruders, may be suitable and are well known to a person skilled in the art.

The invention also relates to the use of the hot-melt adhesive composition as defined above in the laminating of at least two substrates. The substrates can be composed of various materials chosen, for example, from a polyolefin, a polyester, polyacrylic acid, polyvinyl chloride, polystyrene, leather, wood, cellulose, board, paper, concrete, glass or ceramic. Elastic materials can also be used. These substrates can be provided in the form of sheets, films (for example metalized polymer films), cloths, fibers, foams, blocks, yarns, bands or tapes.

Preferably, the invention relates to the use of said composition in the laminating of substrates for the purpose of the manufacture of disposable hygiene articles, such as baby diapers, feminine hygiene articles or adult incontinence articles. Use may be made of any material for the substrates among those mentioned above and of any form of substrate while envisaging all kinds of combinations, the adhesive helping to bond at least two substrates together.

The amount of adhesive applied is generally between 0.5 and 100 grams per square meter, preferably between 1.5 and 15 grams per square meter.

The following examples are given purely by way of illustration of the invention and should not be interpreted in order to limit the scope thereof.

A description is now given of the test methods to which the hot-melt adhesive compositions prepared were subjected.

### Stability Test at 177° C.

The stability at 177° C. of the adhesive composition is evaluated by a test consisting in placing a 200 g sample thereof for 3 days in a ventilated oven brought to 177° C. and in observing each day the possible appearance of a phase separation.

### Brookfield Viscosity at 150° C.

The Brookfield viscosity is measured at 150° C. according to the standard ASTM D3236-73.

Peel Test after 24 Hours and 1 Week

The level of cohesion of the laminated assembly is evaluated by the peel test, the principle of which consists of the determination of the force necessary for the separation (or peeling) of two substrates bonded by the adhesive composition.

Use is made, as a laminating device, of a machine operating continuously at a line speed of approximately 200 m/minute, which machine is sold by Nordson under the name of Coater CTL 4400. In this machine, the coating nozzle is a lip nozzle, the rectangular orifice of which has a length of 2.5 cm and a height of 500 μm; the first substrate coated with adhesive composition is brought into contact with the second substrate using two pressure rolls.

The two substrates employed are:
a film of polyethylene (PE) with a thickness of 20 μm and a width of 15 cm, and
a 10 g/m² nonwoven cloth with the same width composed of fibers of polypropylene (PP) having a diameter of 10 μm.

These two substrates are packaged as a reel with a width of 15 cm.

The adhesive composition to be tested is heated in the melting pot at 160° C. and is then coated on the polyethylene film, resulting in the deposition over the latter of a continuous layer in the form of a strip with a width of 2.5 cm and a thickness of approximately 5 μm, which strip is positioned perpendicular to the axis of the reel and at the center of the width of said film. The amount of adhesive composition applied in the coated region in the form of a strip is 5 g/m². The nonwoven PP cloth is laminated over the PE film thus coated.

The assembly obtained is left at ambient temperature and at 50% relative humidity for 24 hours. The laminated strip with a width of 2.5 cm corresponding to the coated region is then cut out so as to obtain a test specimen of rectangular shape with a length of approximately 10 cm.

The two individual substrates are separated, starting from one end of the test specimen of laminated strip and over approximately 2 cm. The two free ends thus obtained are fixed to two clamping devices respectively connected to a stationary part and a movable part of a tensile testing device which are located on a vertical axis.

While a drive mechanism communicates, to the movable part, a uniform speed of 300 mm/minute, resulting in the separation of the two layers, the separated ends of which are gradually displaced along a vertical axis while forming an angle of 180°, the stationary part, connected to a dynamometer, measures the force withstood by the test specimen thus held.

The result, corresponding to the peeling after 24 hours, is expressed in N/cm.

The peeling after 1 week is measured in the same way, the assembly obtained after manufacture being left to stand for 1 week at ambient temperature and 50% relative humidity.

### Polyamide PA

Use is made in the examples of a polyamide (hereinafter denoted by PA) having a Brookfield viscosity at 205° C. of approximately 5 Pa·s, which polyamide is obtained by reaction:
of a mixture of diacids comprising, in moles, 85% of a fatty acid dimer comprising approximately 18 carbon atoms and 15% of adipic acid with
a mixture of diamines comprising, in moles, 90% of piperazine and 10% of ethylenediamine.

### Supramolecular Polymer SUPRA

Use is made, in the examples, as supramolecular polymer, of SUPRA as defined above.

### EXAMPLE 1

### (Reference): Hot-Melt Adhesive Composition Comprising 100% of Polyamide PA

The stability test at 177° C. gives an acceptable result: no phase separation is recorded after 3 days.

The Brookfield viscosity at 150° C. is 26 Pa·s.

The result of the peel test after 24 hours and 1 week is, in both cases, 0.4 N/cm.

### EXAMPLE 2

### Hot-Melt Adhesive Composition Comprising 70% of Polyamide PA and 30% of SUPRA

A composition homogeneous in the molten state, comprising 70% of polyamide PA and 30% of SUPRA, is prepared by simple blending using a three-bladed mixer under hot conditions (temperature of 170° C.).

The stability test at 177° C. gives an acceptable result: no phase separation is recorded after 3 days.

The Brookfield viscosity at 150° C. is 4 Pa·s.

The result of the peel test after 24 hours and 1 week is, in both cases, 1 N/cm.

This composition thus exhibits, with respect to the reference, a reduced viscosity at 150° C. while giving a level of cohesion which is more than doubled at ambient temperature.

### EXAMPLE 3

### Hot-Melt Adhesive Composition Comprising 90% of Polyamide PA and 10% of SUPRA

Example 2 is repeated while preparing a composition comprising 90% of polyamide PA and 10% of SUPRA.

A composition is also obtained which is homogeneous and stable according to the test at 177° C.

The Brookfield viscosity at 150° C. is 12 Pa·s.

The result of the peel test after 24 hours and 1 week is, in both cases, 0.7 N/cm.

### EXAMPLE 4

### (Comparative): Hot-Melt Adhesive Composition Comprising 70% of EVA and 30% of SUPRA

Example 2 is repeated, the polyamide PA being replaced with a copolymer of ethylene and of vinyl acetate (EVA) obtained from a mixture consisting of 33% of vinyl acetate and 67% of ethylene, having a Melt Flow Index (MFI) of 45 g/10 minutes and available commercially under the name Evatane 33-45 from Arkema.

A composition is also obtained which is homogeneous in the molten state.

The stability test at 177° C. reveals a phase separation from 1 day.

### EXAMPLE 5

### (Comparative): Hot-Melt Adhesive Composition Comprising 70% of an Ethylene Copolymer and 30% of SUPRA

Example 4 is repeated while using a copolymer of ethylene and of octene having a density of 0.870 which is obtained by metallocene catalysis from a mixture comprising ethylene and between 1 and 10% of octene. This copolymer has a Melt Flow Index (MFI) of 1000 g/10 minutes and is available commercially under the name Affinity GA 1900 from Dow Chemical.

The same results are obtained.

### EXAMPLE 6

### (Comparative): Hot-Melt Adhesive Composition Comprising 70% of a Polypropylene Homopolymer (Metallocene Catalysis) and 30% of SUPRA

Example 4 is repeated while using a polypropylene homopolymer obtained by metallocene catalysis which is available commercially under the name Licocène PP 1602 from Clariant.

The same results are obtained.

### EXAMPLE 7

### (Comparative): Hot-Melt Adhesive Composition Comprising 70% of SIS and 30% of SUPRA

Example 4 is repeated while using a styrene block copolymer of SIS (styrene/isoprene/styrene) type having a styrene content of 44% and a content of SI diblock of 0%, which copolymer is available commercially under the name Vector 4411 from Dexco Polymers.

The SIS and the SUPRA are incompatible and do not make possible the preparation of a homogeneous blend.

1. A hot-melt adhesive composition comprising:
from 20 to 95% of a polyamide, and
from 5 to 80% of a supramolecular polymer, obtained by reaction between 1-(2-aminoethyl)-2-imidazolidone (UDETA) and a mixture comprising:
from 51 to 100% of one or more identical or different fatty acid dimers and/or of one or more identical or different fatty acid trimers; and
from 0 to 49% of one or more identical or different fatty acid monomers.

2. The hot-melt adhesive composition as claimed in claim 1, characterized in that the polyamide is capable of being obtained by:
a condensation reaction of a diacid chosen from fatty acid dimers, dodecanedioic acid, sebacic acid, azelaic acid and adipic acid with a diamine chosen from ethylenediamine, piperazine, hexamethylenediamine, diethylenetriamine, triethylenetetramine, dipiperidylpropane and a polyoxypropylenediamine; or else
a polymerization reaction of a linear or cyclic amino acid chosen from caprolactam, lauryllactam or 11-aminoundecanoic acid.

3. The hot-melt adhesive composition as claimed in claim 2, characterized in that use is made, as diacid, of a fatty acid dimer, adipic acid or their mixture and, as diamine, of piperazine, ethylenediamine or their mixture.

4. (canceled)

5. (canceled)

6. (canceled)

7. The hot-melt adhesive composition as claimed in claim 1, characterized in that the supramolecular polymer is capable of being obtained by a reaction, according to substantially stoichiometric amounts, of UDETA with a mixture of monomeric and/or dimeric and/or trimeric fatty acids resulting from the polymerization of predominantly C₁₈ unsaturated monomeric fatty acids, said mixture comprising:
from 1 to 3% of monomers,
from 75 to 80% of dimers, and
from 18 to 22% of trimers.

8. (canceled)

9. The hot-melt adhesive composition as claimed in claim 1, characterized in that it comprises from 65 to 95% of polyamide and from 5 to 35% of supramolecular polymer.

10. A method of laminating of substrates for the purpose of the manufacture of disposable hygiene articles, comprising laminating said substrates together using a hot melt adhesive composition according to claim 1.

11. The hot-melt adhesive composition as claimed in claim 2, characterized in that the supramolecular polymer is capable of being obtained by a reaction, according to substantially stoichiometric amounts, of UDETA with a mixture of monomeric and/or dimeric and/or trimeric fatty acids resulting from the polymerization of predominantly C₁₈ unsaturated monomeric fatty acids, said mixture comprising:
from 1 to 3% of monomers,
from 75 to 80% of dimers, and
from 18 to 22% of trimers.

12. The hot-melt adhesive composition as claimed in claim 3, characterized in that the supramolecular polymer is capable of being obtained by a reaction, according to substantially stoichiometric amounts, of UDETA with a mixture of monomeric and/or dimeric and/or trimeric fatty acids resulting from the polymerization of predominantly C₁₈ unsaturated monomeric fatty acids, said mixture comprising:
from 1 to 3% of monomers,
from 75 to 80% of dimers, and
from 18 to 22% of trimers.

13. The hot-melt adhesive composition as claimed in claim 2, characterized in that it comprises from 65 to 95% of polyamide and from 5 to 35% of supramolecular polymer.

14. The hot-melt adhesive composition as claimed in claim 3, characterized in that it comprises from 65 to 95% of polyamide and from 5 to 35% of supramolecular polymer.

15. The hot-melt adhesive composition as claimed in claim 7, characterized in that it comprises from 65 to 95% of polyamide and from 5 to 35% of supramolecular polymer.

16. The hot-melt adhesive composition as claimed in claim 11, characterized in that it comprises from 65 to 95% of polyamide and from 5 to 35% of supramolecular polymer.

17. The hot-melt adhesive composition as claimed in claim 12, characterized in that it comprises from 65 to 95% of polyamide and from 5 to 35% of supramolecular polymer.
